(19) United States
(12) Patent Application Publication
(10) Pub. No.: US 2026/0113710 A1
(43) Pub. Date: Apr. 23, 2026

(54) METHOD, SYSTEM, AND APPARATUS FOR COMMUNICATION DEVICE WAKE-UP

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/412,196

(22) Filed: Dec. 8, 2025

Related U.S. Application Data
(63) Continuation of application No. PCT/CN2023/136765, filed on Dec. 6, 2023.
(60) Provisional application No. 63/507,302, filed on Jun. 9, 2023.

(51) Int. Cl. H04W 52/02; H04L 27/10; H04W 56/00

(52) U.S. Cl. CPC H04W 52/0235; H04L 27/10; H04W 56/0015

(57) ABSTRACT

Embodiments of the present application provide a communication method and a communication apparatus. The method includes: receiving, in a first state, wake-up signals comprising multiple first signals and multiple second signals, where the multiple first signals and the multiple second signals are linear frequency modulated (LFM) signals; obtaining signatures associated with the multiple second signals based on a timing information of the multiple second signals, and the timing information obtained from at least part of the multiple first signals; and transitioning from the first state to a second state based on the signatures associated with the multiple second signals. The receiving apparatus can process the multiple first signals for a purpose of obtaining timing information of the multiple second signals. The timing information allows the receiving apparatus to reliably obtain the signatures associated with the multiple second signatures.

### CROSS-REFERENCE TO RELATED APPLICATIONS

The present application is a continuation of International Application No. PCT/CN2023/136765, filed on Dec. 6, 2023, which claims the benefit of U.S. Provisional Patent Application No. 63/507,302, filed on Jun. 9, 2023.

The disclosures of the aforementioned applications are hereby incorporated by reference in their entireties.

### TECHNICAL FIELD

Embodiments of the present application relate to the field of communications, and more specifically, to a communication method and a communication apparatus.

### BACKGROUND

In a communication system, a node may transition into an idle or inactive mode to reduce the power consumption. A node in the idle or inactive mode monitors wake-up signals (WUS), where the WUS are used to trigger the node to exit the idle or inactive mode. This procedure in which a node is woken up may be called a wake-up (WU) procedure. The processing of the WUS may depend on time synchronization between the receiving side and transmitting side of the WUS. Synchronization offset between the receiving side and transmitting side may cause an abnormal WU procedure.

Therefore, how to improve the reliability of the WU procedure becomes an urgent problem to be solved.

### SUMMARY

Embodiments of the present application provide a communication method and a communication apparatus. The technical solutions may improve the reliability of a WU procedure.

According to a first aspect, an embodiment of the present application provides a communication method, and the method may be performed by a receiving apparatus. The method includes: receiving, in a first state, wake-up signals comprising multiple first signals and multiple second signals, where the multiple first signals and the multiple second signals are linear frequency modulated (LFM) signals; obtaining signatures associated with the multiple second signals based on a timing information of the multiple second signals, and the timing information obtained from at least part of the multiple first signals; and transitioning from the first state to a second state based on the signatures associated with the multiple second signals.

According to a second aspect, an embodiment of the present application provides a communication method, and the method may be performed by a transmitting apparatus. The method includes: transmitting wake-up signals comprising multiple first signals and multiple second signals, where the multiple first signals and the multiple second signals are linear frequency modulated (LFM) signals, signatures associated with the multiple second signals are obtained based on a timing information, the timing information is obtained from at least part of the multiple first signals, and the signatures associated with the multiple second signals are used for a receiving apparatus to transition from a first state to a second state.

According to the above technical solution, signatures associated with the multiple second signals are based on a timing information obtained from at least part of the multiple first signals. That is, the receiving apparatus can process the multiple first signals for a purpose of obtaining timing information of the multiple second signals. The timing information allows the receiving apparatus to reliably obtain the signatures associated with the multiple second signatures. Thus, the reliability of the WU procedure can be improved.

With reference to the first aspect or the second aspect, in some embodiments, LFM rates of the multiple first signals are the same.

According to the above technical solution, processing of a single LFM signal is a function of the LFM rate of this LFM signal. LFM rates of the multiple first signals are the same so that the receiving apparatus may process the multiple first signals based on a same LFM rate. Thus, the processing complexity of the receiving apparatus can be reduced.

With reference to the first aspect or the second aspect, in some embodiments, LFM rates of the multiple first signals and LFM rates of the multiple second signals are the same.

According to the above technical solution, the receiving apparatus may process the multiple first signals and the multiple second signals based on a same LFM rate. The processing complexity of the receiving apparatus can be reduced.

With reference to the first aspect or the second aspect, in some embodiments, time durations of the multiple first signals are the same.

According to the above technical solution, the receiving apparatus may process the multiple first signals based on a same time duration. The processing complexity of the receiving apparatus can be reduced.

With reference to the first aspect or the second aspect, in some embodiments, time durations of the multiple first signals and time durations of the multiple second signals are the same.

According to the above technical solution, the receiving apparatus may process the multiple first signals and the multiple second signals based on a same time duration. The processing complexity of the receiving apparatus can be reduced.

With reference to the first aspect or the second aspect, in some embodiments, a total time duration of the multiple first signals is greater than or equal to a first threshold.

According to the above technical solution, the receiving apparatus may capture a large fraction of the multiple first signals when the total time duration of the multiple first signals is great. The reliability of the timing information obtained from the first signals can be improved. Thus, the reliability of the WU procedure can be further improved.

With reference to the first aspect or the second aspect, in some embodiments, a total time duration of the multiple first signals is determined at least based on a first information, and the first information indicates a communication environment of the receiving apparatus.

According to the above technical solution, a synchronization offset between the receiving apparatus and the transmitting apparatus is related to the communication environment. For example, the synchronization offset in a complex communication environment may be greater than the synchronization offset in a simple communication environment. The total time duration of the multiple first signals is determined at least based on the communication environment. Thus, the reliability of the WU procedure can be further improved.

With reference to the first aspect or the second aspect, in some embodiments, the timing information indicates positions of the multiple second signals in a time domain.

According to the above technical solution, the receiving apparatus could obtain multiple second signals by separating them from obtained signals based on the timing information. The reliability of the WU procedure can be further improved.

With reference to the first aspect or the second aspect, in some embodiments, the timing information includes a synchronization offset between the receiving apparatus and a transmitting apparatus, the synchronization offset is obtained from at least part of the multiple first signals.

According to the above technical solution, the receiving apparatus could process the multiple first signals for a purpose of timing synchronization. The reliability of the WU procedure can be improved.

With reference to the first aspect or the second aspect, in some embodiments, the signatures associated with the multiple second signals includes at least one or more of the following: time durations of the multiple second signals, starting frequencies of the multiple second signals, and LFM rates of the multiple second signals.

According to the above technical solution, the signatures associated with the multiple second signals are used for the receiving apparatus to transition from the first state to the second state. The receiving apparatus can obtain the signatures by simple processing on LFM signals. The complexity of the WU procedure can be reduced.

With reference to the first aspect, in some embodiments, the method further includes: receiving first configuration information, where the first configuration information indicates configurations of the multiple first signals, and the configurations of the multiple first signals include one or more of the following: a starting time of the multiple first signals, a total time duration of the multiple first signals, time durations of the multiple first signals, starting frequencies of the multiple first signals, and LFM rates of the multiple first signals.

With reference to the second aspect, in some embodiments, the method further includes: transmitting first configuration information, where the first configuration information indicates configurations of the multiple first signals, and the configurations of the multiple first signals include one or more of the following: a starting time of the multiple first signals, a total time duration of the multiple first signals, time durations of the multiple first signals, starting frequencies of the multiple first signals, and LFM rates of the multiple first signals.

According to the above technical solution, the transmitting apparatus may process the multiple first signals based on the first configuration information, to obtain the timing information of the multiple second signals. Thus, the reliability of the WU procedure can be improved.

With reference to the first aspect or the second aspect, in some embodiments, the configurations of the multiple first signals are associated with a cell identifier.

According to the above technical solution, one or more of apparatus associated with the cell identifier can use the same configurations of the multiple signals.

With reference to the first aspect, in some embodiments, the method further includes: receiving second configuration information, where the second configuration information indicates configurations of the multiple second signals, and the configurations of the multiple second signals include one or more of the following: time durations of the multiple second signals, starting frequencies of the multiple second signals, LFM rates of the multiple second signals, and a total time duration of the multiple second signals.

With reference to the second aspect, in some embodiments, the method further includes: transmitting second configuration information, where the second configuration information indicates configurations of the multiple second signals, and the configurations of the multiple second signals include one or more of the following: time durations of the multiple second signals, starting frequencies of the multiple second signals, LFM rates of the multiple second signals, and a total time duration of the multiple second signals.

According to the above technical solution, the transmitting apparatus may process the multiple second signals based on the second configuration information, to determine to transition from the first state to the second state. Thus, the reliability of the WU procedure can be improved.

With reference to the first aspect, in some embodiments, the method further includes: transmitting feedback information in the second state, where the feedback information indicates a synchronization offset between the receiving apparatus and a transmitting apparatus, and the synchronization offset is obtained based on at least part of the multiple first signals.

With reference to the second aspect, in some embodiments, the method further includes: receiving feedback information in the second state, where the feedback information indicates a synchronization offset between the receiving apparatus and a transmitting apparatus, and the synchronization offset is obtained based on at least part of the multiple first signals.

With reference to the first aspect or the second aspect, in some embodiments, the synchronization offset is used to adjust a total time duration of the multiple first signals.

According to the above technical solution, the transmitting apparatus transmits the feedback information after transition into the second state. The transmitting apparatus may adjust configurations of the wake-up signals based on the feedback information. The reliability of the WU procedure can be further improved.

With reference to the first aspect or the second aspect, in some embodiments, configurations of the multiple first signals are shared among multiple apparatus.

According to the above technical solution, the transmitting apparatus may share the same configurations of the multiple first signals with other apparatus, large transmit power budget could be assigned to the multiple first signals because multiple apparatus may share the multiple first signals for timing synchronization. The quality of timing synchronization could be improved. Thus, the reliability of the WU procedure can be further improved.

With reference to the first aspect or the second aspect, in some embodiments, power consumption corresponding to the first state is lower than power consumption corresponding to the second state.

According to the above technical solution, for example, the first state may be an idle state (or mode), an inactive state (or mode), or other low-power consumption states. The second state may be a connected state (mode) or other states with higher power consumption than the first state.

According to a third aspect, a receiving apparatus is provided. The receiving apparatus includes a function or unit configured to perform the method according to the first aspect or any one of the possible embodiments of the first aspect.

For example, the receiving apparatus could be a network device or a chip in the network device. For another example, the receiving apparatus could be a terminal device or a chip in the terminal device.

According to a fourth aspect, a transmitting apparatus is provided. The transmitting apparatus includes a function or unit configured to perform the method according to the second aspect or any one of the possible embodiments of the second aspect.

For example, the transmitting apparatus could be a terminal device or a chip in the terminal device. For another example, the transmitting apparatus could be a network device or a chip in the network device.

According to a fifth aspect, a system is provided. The system includes: the transmitting apparatus according to the third aspect and the receiving apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a transmitting apparatus. For example, the communication apparatus may be a network device or a component (for example, a chip or integrated circuit) installed in the network device. For another example, the communication apparatus may be a terminal device or a component (for example, a chip or integrated circuit) installed in the terminal device.

With reference to the sixth aspect, in some implementations of the sixth aspect, the communication apparatus may be a receiving apparatus. For example, the communication apparatus may be a terminal device or a component (for example, a chip or integrated circuit) installed in the terminal device. For another example, the communication apparatus may be a network device or a component (for example, a chip or integrated circuit) installed in the network device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible embodiments of the first aspect, or the second aspect or any one of the possible embodiments of the second aspect.

According to an eighth aspect, a computer storage medium is provided. The computer storage medium stores program code, and the program code is used to execute one or more instructions for the method according to the first aspect or any one of the possible embodiments of the first aspect, or the second aspect or any one of the possible embodiments of the second aspect.

According to a ninth aspect, this application provides a computer program product including one or more instructions, where when the computer program product runs on a computer, the computer performs the method according to the first aspect or any one of the possible embodiments of the first aspect, or the second aspect or any one of the possible embodiments of the second aspect.

### DESCRIPTION OF DRAWINGS

FIG. 1 is a schematic diagram of an application scenario according to this application;

FIG. 2 illustrates an example communication system 100;

FIG. 3 illustrates another example of an ED and a base station;

FIG. 4 is a schematic diagram of one LFM signal;

FIG. 5 is a schematic diagram of an example of wake-up signals;

FIG. 6 is a schematic flowchart of a communication method 600 according to an embodiment of this application;

FIG. 7 illustrates an example of M first signals and N second signals according to an embodiment of this application;

FIG. 8 illustrates the first example of M first signals according to an embodiment of this application;

FIG. 9 illustrates the second example of M first signals according to an embodiment of this application;

FIG. 10 illustrates the third example of M first signals according to an embodiment of this application;

FIG. 11 illustrates an example of two groups of first signals according to an embodiment of this application;

FIG. 12 is a schematic block diagram of an example of a receiving apparatus according to an embodiment of this application;

FIGS. 13-17 are schematic block diagrams of possible devices according to embodiments of this application.

### DESCRIPTION OF EMBODIMENTS

The following describes technical solutions of the present application with reference to the accompanying drawings.

The technical solutions in embodiments of this application may be applied to various communications systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new radio (NR) wireless communications system, a sixth generation (6G) wireless communications system, integrated access and backhaul (JAB) system, a mesh network, a side link system, or other evolving communications systems. The technical solutions in embodiments of this application may be applied to the communication system that integrates the above two or more systems.

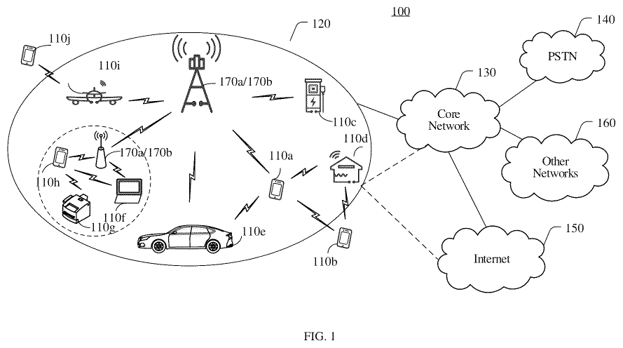

For ease of understanding the embodiments of this application, a communications system shown in FIGS. 1-3 is first used as an example to describe in detail a communications system to which the embodiments of this application are applicable.

FIG. 1 is a schematic diagram of an application scenario according to this application. Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

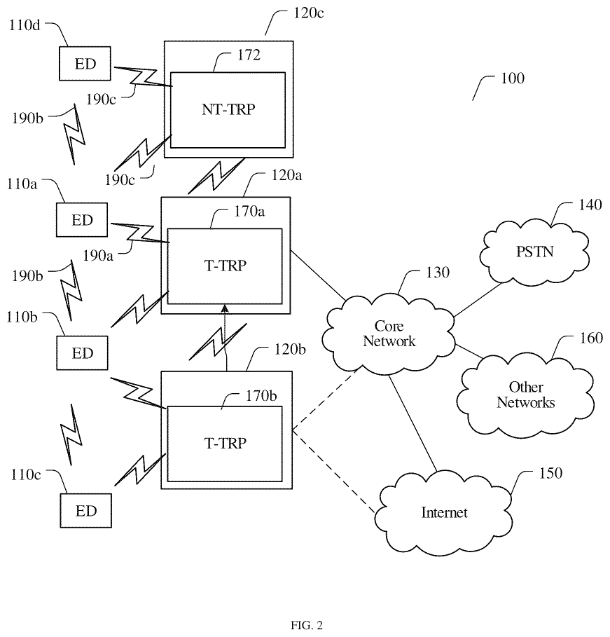

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such.

FIG. 3 illustrates another example of an ED and a base station. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, an NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to output or modulate data or other content for transmission by at least one antenna 204 or interface. The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The transceiver may also be known as an interface, for inputting and outputting operations.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g., communication module, modem, or chip) in the foregoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

Embodiments of this application can be applied to any communication scenario where one or more transmitting apparatus communicate with one or more receiving apparatus. In a first example, the transmitting apparatus may be a network device (e.g., T-TRP or NT-TRP) or a chip in the network device, and the receiving apparatus may be a terminal device (e.g., ED) or a chip in the terminal device. In a second example, the transmitting apparatus may be a network device or a chip in the network device, and the receiving apparatus may be another network device or a chip in the network device. In a third example, the transmitting apparatus may be a terminal device or a chip in the terminal device, and the receiving apparatus may be another terminal device or a chip in the terminal device. This is not limited in this application. The following embodiments are illustrative of one transmitting apparatus and one receiving apparatus.

For ease of understanding the embodiments of this application, the terms involved in this application are briefly explained below.

### 1. WU Procedure

The WU procedure allows a node (which is an example of the receiving apparatus) to transition from a first state to a second state, where power consumption of the node in the first state is less than that of the node in the second state. For example, a node may turn off some circuitry (that is, the node transitions into the first state) to reduce the power consumption when the node has no data to receive from or send to other nodes. The node can turn on the circuitry (that is, the node transitions from the first state to the second state) when the node has data to receive from other nodes. The node in the first state does not know that it has data to receive, a WU procedure is necessary for the node to transition from the first state to the second state. The transition of the node from the first state to the second state can also be referred to as the node being woken up.

For example, a transmitting apparatus may transmit wake-up signals (WUS) to a receiving apparatus, to make the receiving apparatus transition from the first state to the second state. In some embodiments of this application, the first state may be an idle state (or mode), an inactive state (or mode), or other low-power consumption states. The second state may be a connected state (mode) or other states with higher power consumption than the first state.

The above WU procedure is only illustrative; this is not limited in this application.

### 2. Wake-Up Signals (WUS)

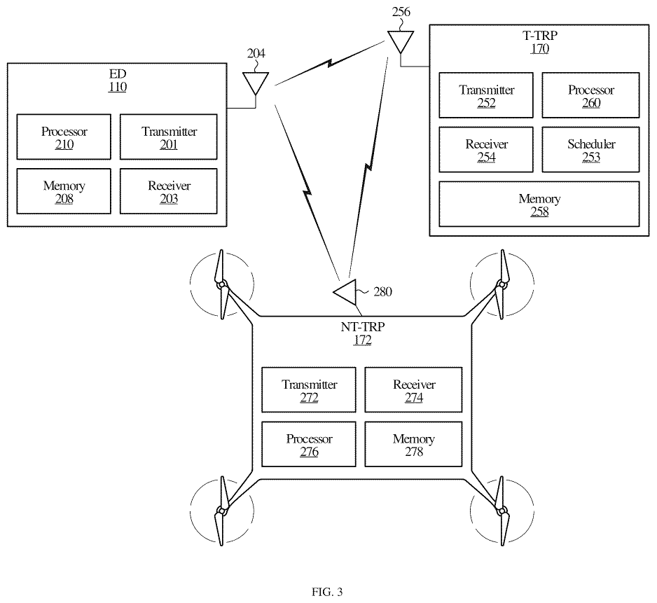

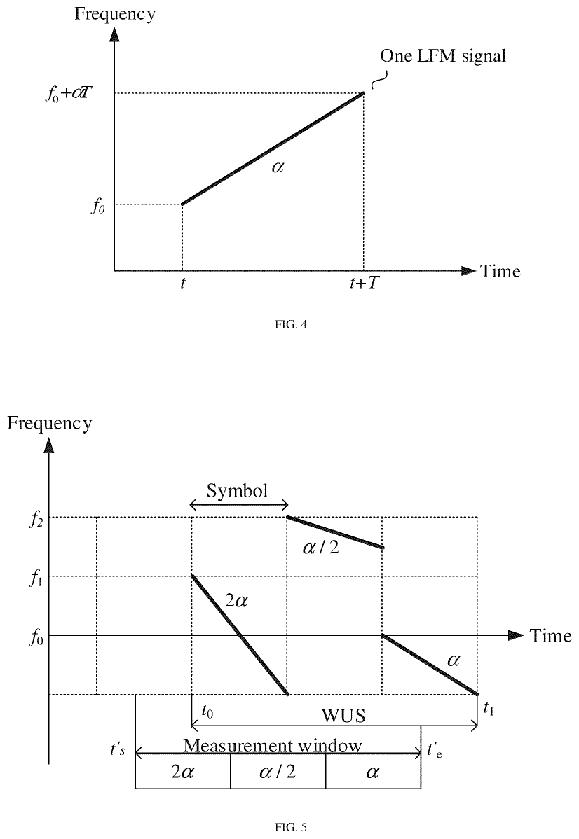

The WUS may include one or more linear frequency modulated (LFM) signals. One LFM signal is a signal whose frequency is a linear function of time with a slope. The LFM signal can be also named as a chirp signal. For ease of understanding the embodiments of this application, one LFM signal is introduced in combination with FIG. 4.

FIG. 4 is a schematic diagram of one LFM signal. As shown in FIG. 4, a starting time of the LFM signal is represented by “t”, a time duration of the LFM signal is represented by “T”, an ending time of the LFM signal is represented by “t+T”, a starting frequency (which may also be called frequency hopping) of the LFM signal is represented by “fₒ”, a LFM rate of the LFM signal is represented by “a”, and an ending frequency of the LFM signal is represented by “fₒ+αT”. The LFM rate of the LFM signal is the slope of the linear function.

One LFM signal may be indicated by one or more parameters, where the one or more parameters may be used to determine a position of the LFM signal in a time domain and a frequency domain. Based on the linear properties of the LFM signal, the one or more parameters may be a variety of parameter combinations that can determine the LFM signal. For example, the one or more parameters may be a starting time, a time duration, a starting frequency, and a LFM rate. For another example, the one or more parameters may be a starting time, an ending time, a starting frequency, and an ending frequency. This is not limited in this application.

Designing the WUS based on LFM signals can reduce the processing complexity and power consumption of the receiving apparatus compared with the WUS based on some other types of signals. For example, the receiving apparatus can process LFM signals using de-chirp processing. One LFM signal of the form

$${e}^{j 2 π ( \frac{α}{2} {t}^{2} + {f}_{0} t )}$$

is transmitted to the receiving apparatus, where a delay of a single path propagation channel between the transmitting apparatus and the receiving apparatus is represented by “τ”, a frequency Doppler shift of the single path propagation channel is represented by “f_{D}”. Thus, the LFM signal received by the receiving apparatus may be represented by y(t)=βe^{j2πf}^{_{D}}^{t}x(t−T)+n(t), where n(t) represents the noise signal. The de-chirp processing corresponds to multiplying the received signal y(t) by the LFM signal d(t)=e^{-jπαat}^{²}. Note that d(t) is similar to x(t) except for the sign of the LFM rate. This processing transforms the received signal y(t) into an exponential signal, where the exponent is a linear function of delay and doppler frequency shift. The operation that the receiving apparatus performs on the received signal y(t) is not limited in this application. For example, receiving apparatus may perform fast Fourier transformation (FFT) on the received signal to estimate the exponent of the signal after de-chirp processing. After de-chirp processing, the required sampling frequency may be much smaller than the original LFM signal bandwidth (i.e., x(t)) and a low frequency sampling may be applied. Thus, the power consumption of the receiving apparatus can be reduced.

WUS may include multiple LFM signals, a configuration information of the WUS used to wake up the receiving apparatus is known to the receiving apparatus. For example, the configuration information includes: time durations of the multiple LFM signals, LFM rates of the multiple LFM signals, and starting frequencies of the multiple LFM signals. The receiving apparatus may detect whether its corresponding WUS has been transmitted by the transmitting apparatus or not. If the receiving apparatus determines that the transmitting apparatus has sent the corresponding WUS, the receiving apparatus may transition from the first state to the second state. If not, the receiving apparatus may stay in the first state. For ease of understanding the embodiments of this application, an example of WUS is introduced in combination with FIG. 5.

FIG. 5 is a schematic diagram of an example of WUS. The WUS corresponding to a receiving apparatus includes three LFM signals, which are represented by LFM signal #0, LFM signal #1, and LFM signal #2, respectively, in the following description. For the LFM signal #0, a starting frequency is represented by “f₁”, a time duration is equal to a single symbol, a LFM rate is represented by “2α”, and the starting time of the LFM signal #0 is represented by “to”. For the LFM signal #1, a starting frequency is represented by “f₂”, a time duration is equal to a single symbol, and a LFM rate is represented by “α/2”. For the LFM signal #2, a starting frequency is represented by “fₒ” and a time duration is equal to a single symbol, and a LFM rate is represented by “α”. As shown in FIG. 5, these three LFM signals have certain starting frequencies and LFM rates on the three symbols. The receiving apparatus may perform the operations described above to obtain the starting frequencies and the LFM rates, to determine whether its corresponding WUS is transmitted or not.

As shown in FIG. 5, a receiving apparatus determines whether the corresponding WUS is transmitted during a certain period of time. This period of time may be referred to as a time window, a measurement window, a monitoring window, or the like. There is a synchronization offset between the transmitting apparatus and the receiving apparatus, resulting in a mismatch between the measurement window and time duration of the WUS. For example, the time duration of the WUS is from t₀ to t₀, but the measurement window is from t′₀ to t′₁. According to the way a LFM signal is processed by the receiving apparatus, the processing for each LFM signal is a function of the LFM rate, frequency, and time. Since LFM rates on two symbols may be different, it is important for the receiving apparatus to know the position of each LFM signal in a time domain. The processing of the receiving apparatus does not match with the positions of the WUS in the time domain, which can result in a false alarm or misdetection of a WU event.

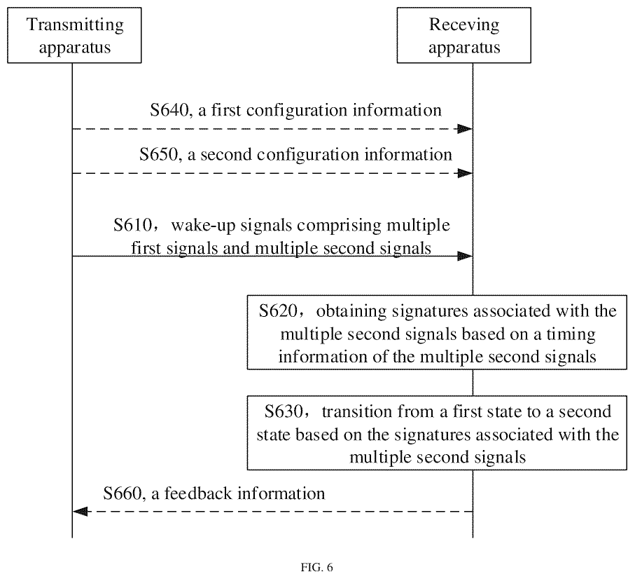

Therefore, this application provides a communication method in which the wake-up signals include multiple first signals and multiple second signals. The receiving apparatus may process the multiple first signals, to obtain timing information of the multiple second signals. The receiving apparatus may process the multiple second signals based on the timing information to obtain the signatures associated with the second signals. The receiving apparatus determines to transition from a first state to a second state based on the signatures. The timing information allows the receiving apparatus to reliably obtain the signatures associated with the multiple second signatures. Thus, the reliability of the WU procedure can be improved. In the following, the communication method provided in this application will be described in combination with FIG. 6.

FIG. 6 is a schematic flowchart of a communication method 600 according to an embodiment of this application. The communication method 600 may be applied to the communications system described above.

At S610, a transmitting apparatus transmits wake-up signals.

Correspondingly, the receiving apparatus, in a first state, receives the wake-up signals.

The wake-up signals include multiple first signals and multiple second signals. The multiple first signals and the multiple second signals are LFM signals. Processing of the multiple second signals is based on a timing information obtained from the multiple first signals. That is, the receiving apparatus can process the multiple first signals for a purpose of obtaining timing information of the multiple second signals. The timing information allows the receiving apparatus to reliably obtain the signatures associated with the multiple second signatures. Thus, the reliability of the WU procedure can be improved.

The number of the multiple first signals and the number of the second signals are not limited in this application. For ease of description, the number of the multiple first signals is represented by M and the number of the multiple second signals is represented by N. M and N can be equal or be different.

The “first signals” is only named for differentiation and does not limit the scope of protection of the embodiments of this application. Similarly, a “second signals,” and a “first information,” etc. in the following description are also only named for differentiation and do not limit the scope of protection of the embodiments of this application, and this will not be repeated below.

In the description of this application, “generating A based on B” and “generating A at least based on B” can have the same meaning. The phrases “determining A based on B” and “determining A at least based on B” also can have a same meaning. This will not be repeated below.

In some embodiments of this application, a position of a signal in a time domain may be referred to as a time duration when the receiving apparatus receives (or detects) this signal. The receiving apparatus knows the position of this signal in the time domain, that is, the receiving apparatus may know the starting time and ending time of this signal.

The receiving apparatus may detect the WUS in a measurement window. The starting time of the measurement window and the starting time of the WUS may not be the same. That is, there may be a time offset between the starting time of the measurement window and the starting time of the WUS. This may result in the receiving apparatus not capturing all the M first signals. Therefore, the receiving apparatus receiving the multiple first signals includes: receiving the whole first signals or receiving part of the first signals. It should be noted that parts of the M first signals can also be used to establish time synchronization.

The measurement window can be configured in a variety of ways. In some embodiments, the length of the measurement window could be determined based on the total time duration of the M first signals and the N second signals. For example, the length of the measurement window is longer than or equal to the total duration of the M first signals and the N second signals. That is, the receiving apparatus may capture more parts of the M first signals in the measurement window.

In some embodiments, the receiving apparatus can periodically measure signals when the receiving apparatus is in a first state. That is, the measurement window may appear periodically, the receiving apparatus enters the first state (which is a low power state) and periodically monitor if its associated WUS has been transmitted by the transmitting apparatus or not. The period of the measurement window is not limited in this application, for example, the period may be configured by a network, or the period may be predefined (for example, predefined in a standard).

In some embodiments, the M first signals and the N second signals occupy T time units, T is greater than or equal to the sum of M and N. The starting time of one first signal is a starting time of one time unit and the time duration of one first signal may be an integer multiple of the time unit. The starting time of one second signal is a starting time of one time unit and the time duration of one second signal may be an integer multiple of the time unit. In some embodiments, the time unit is, but not limited to, a symbol, an orthogonal frequency division multiplexing (OFDM) symbol, and a slot.

For example, 5 first signals and 5 second signals occupy 15 symbols, where one first signal occupies a single symbol and one second signal occupies 2 symbols. The 5 first signals occupy the first 5 symbols of the 15 symbols and the 5 second signals occupy the last 10 symbols of the 15 symbols. The starting time of one first signal is the starting time of one symbol, which can also be referred to as a boundary of a symbol. Similarly, the starting time of one second signal is the starting time of one symbol. Thus, in embodiments of this application, the determination of the starting time of the N second signals can also be described as the determination of the boundary of the time unit.

In some embodiments, the M first signals precede the N second signals. The M first signals may be also referred to as pilots of the WUS. The N second signals may be also referred to as signatures of the WUS. This will not be repeated below.

The M first signals and the N second signals are LFM signals. The description of one LFM signal can be referred to the description in FIG. 4 above and will not be repeated here. For ease of understanding the embodiments of this application, an example of the M first signals and N second signals is illustrated in combination with FIG. 7.

As shown in FIG. 7, a total time duration of the M first signals may be represented by Tₚᵢₗ. The total time duration of the N second signals may be represented by T_{sig}. The starting time of the M first signals may be represented by to. The starting time of the N second signals may be represented by t₁. The ending time of the WUS may be represented by t₂. The starting time of the measurement window may be represented by tₛ′. The ending time of the measurement window may be represented by

$${t}_{e}^{′} .$$

The total time duration of the measurement window may be represented by Tₘₑₐ.

As an example, the time durations of the M first signals and the N second signals are the same, which is equal to a single time unit. The starting frequencies of the M first signals are the same, which is equal to fₒ. The starting frequencies of at least two second signals may be different, where the stating frequencies of the first three signals may be equal to f₁, f₂ and fₒ and the last two signals may be equal to f₁ and f₀ in FIG. 7. The LFM rates of the M first signals and the N second signals are the same, which is equal to α.

It can be seen from FIG. 7, for the existence of the synchronization offset, the receiving apparatus may miss some of the M first signals. That is, the receiving apparatus may capture some of the M first signals in the measurement window. This will not affect the receiving apparatus to determine the starting time of the N second signals and the synchronization offset.

It should be noted that the M first signals and the N second signals shown in FIG. 7 are just an example for ease of understanding. In some embodiments, the M first signals and the N second signals may be designed separately. For ease of understanding of this application, the M first signals are described in detail below.

Time durations of the M first signals may be the same or different, this is not limited in this application. In some embodiments, the time durations of the M first signals may be different. The transmitting apparatus may indicate the time duration of each first signal to the receiving apparatus. For example, a time duration sequence [symbol] ₚᵢₗ=(T₁, T₂, . . . , T_{M}) may be used to represent the time durations of the M first signals. The transmitting apparatus may transmit the time duration sequence to the receiving apparatus. In some embodiments, the time durations of the M first signals may be the same, which can reduce the complexity of processing the M first signals. For example, a single first signal can occupy a symbol. The M first signals may occupy M contiguous symbols. The time durations of the M first signals may be represented by a time duration parameter “Tₚᵢₗₒ”. The time duration sequence [symbol] _{Pil} and the time duration parameter “Tₚᵢₗₒ” in the following description represent a similar meaning and will not be repeated below.

LFM rates of the M first signals may be the same or different, this is not limited in this application. In some embodiments, the LFM rates of the M first signals may be different. The transmitting apparatus may indicate the LFM rate of each first signal to the receiving apparatus. For example, an LFM rate sequence [symbol] ₚᵢₗ=(α₁, α₂, . . . , α_{M}) may be used to represent the LFM rates of the M first signals. The transmitting apparatus may transmit the LFM rate sequence to the receiving apparatus. In some embodiments, the LFM rates of the M first signals may be the same. The LFM rates of the M first signals may be represented by a LFM rate parameter “αₚᵢₗ.” The LFM rate sequence [symbol] ₚᵢₗ and LFM rate parameter “αₚᵢₗ” in the following description represent a similar meaning and will not be repeated below. When the LFM rates of the M first signals are the same, that is, the LFM rates do not change across the time units, the receiving apparatus may apply a same processing (for example de-chirp processing) to the first signals before taking samples. The processing complexity of the receiving apparatus can be reduced, and the power consumption can be reduced.

Starting frequencies of the M first signals may be the same or different, this is not limited in this application. In some embodiments, the starting frequencies of the M first signals may be different. The transmitting apparatus may indicate the starting frequency of each first signal to the receiving apparatus. For example, a starting frequency sequence [symbol] ₚᵢₗ=(f₁, f₂, . . . , f_{M}) may be used to represent the starting frequencies of the M first signals. The transmitting apparatus may transmit the starting frequency sequence to the receiving apparatus. In some embodiments, the starting frequencies of the M first signals may be the same. The starting frequencies of the M first signals may be represented by a starting frequency parameter “fₚᵢₗ” The starting frequency sequence [symbol] ₚᵢₗ and the starting frequency parameter “fₚᵢₗ” in the following description represent a similar meaning and will not be repeated below.

In some embodiments, at least one of starting frequencies, time durations, and LFM rates of the M first signals is different, the M first signals may be determined arbitrarily. Alternatively, the starting frequencies, time durations, and the LFM rates for the M first signals are the same. For ease of understanding the embodiments of this application, three examples of the M first signals are illustrated in combination with FIGS. 8-10.

In a first example, as shown in FIG. 8, time durations, starting frequencies and LFM rates of the M first signals are different, and may be represented by a time duration sequence [symbol] ₚᵢₗ=(T₁, T₂, . . . , T_{M}), a starting frequency sequence [symbol] ₚᵢₗ=(f₁, f₂, . . . , f_{M}) and a LFM rate sequence [symbol] ₚᵢₗ=(α₁, α₂, . . . , α_{M}), respectively.

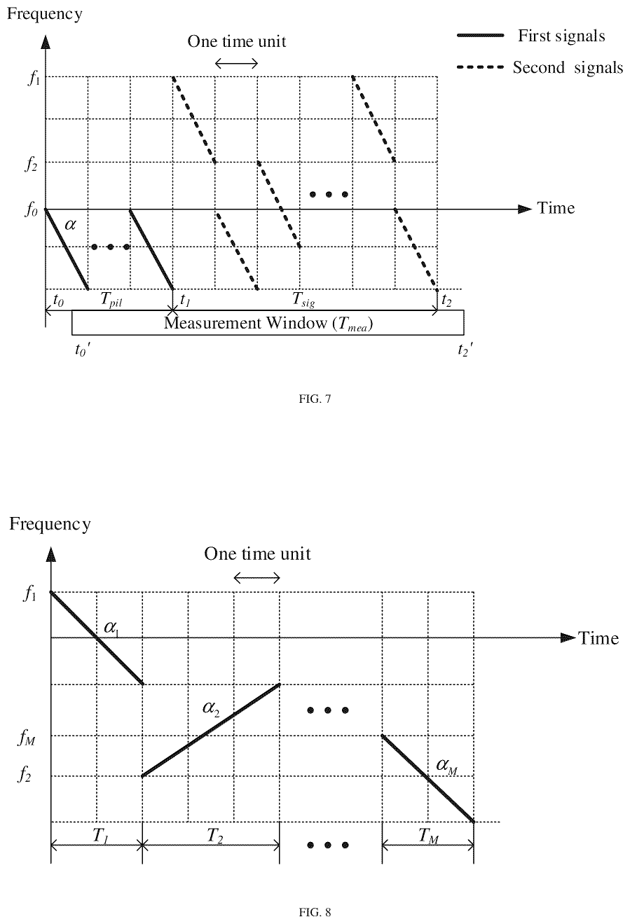

In a second example, as shown in FIG. 9, time durations of the M first signals are the same, which may be represented by a time duration parameter T, and equal to a single time unit. The LFM rates of the M first signals are not the same, for example, the LFM rates of two adjacent first signals are opposite. The LFM rates of the M first signals may be indicated by the LFM rate sequence [symbol] ₚᵢₗ=(−α, α, . . . , −α, α), or the transmitting apparatus knows that LFM rates of two adjacent first signals are opposite and a LFM rate parameter “α” may be used to indicate the LFM rates of the M first signals. The starting frequencies of the M first signals are different, starting frequency of one first signal is f₀ and starting frequency of the next first signal is f₀−B, where “B” represents the bandwidth occupied by a first signal and a value of the “B” is equal to α*T. The starting frequencies of the first signals may be indicated by the starting frequency sequence [symbol] ₚᵢₗ=(f₀, f₀−B, . . . , f₀, f₀−B), or starting frequency parameters f₀ and B may be used to indicate the starting frequencies of the M first signals. This is not limited in this application.

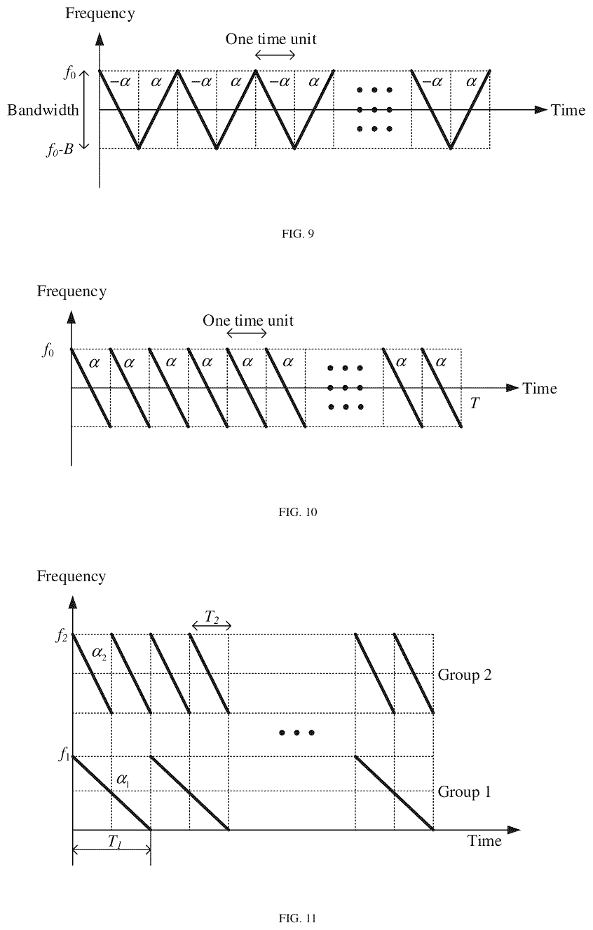

In a third example, as shown in FIG. 10, time durations of the M first signals are the same, which may be indicated by a time duration parameter Tₚᵢₗₒ, and equal to a single time unit. Starting frequencies of the M first signals are the same, which may be indicated by a starting frequency parameter fₚᵢₗ(where fₚᵢₗ=fₒ in FIG. 10). LFM rates of the M first signals are the same, which may be indicated by a LFM rate parameter αₚᵢₗ(where αₚᵢₗ=a in FIG. 10).

In some embodiments, the total time duration of the M first signals may be greater than or equal to a first threshold. For ease of description, the total time duration of the M first signals may be represented by Tₚᵢₗ, which is equal to

$${\sum }_{i = 1}^{M} {T}_{i} .$$

The total time duration of the M first signals may be sufficiently large so that the receiving apparatus captures a sufficiently large fraction of the M first signals in the measurement window, and the receiving apparatus may determine the boundaries of time units based on the captured signals.

In some embodiments, the total time duration may be determined at least based on a first information, where the first information indicates a communication environment of the receiving apparatus. For example, the total time duration for complex communication environments may be greater than the total time duration for simple communication environments. Delay between the transmitting apparatus and the receiving apparatus may be large in complex communication environments, the total time duration of the M first signals may be set larger in order to enable the receiving apparatus to obtain as many first signals as possible in the measurement window for time synchronization.

The transmitting apparatus may determine the total time duration Tₚᵢₗ. In some embodiments, the time durations of the M first signals are the same (which is equal to T), the total time duration Tₚᵢₗ=MT. For example, time duration T of one first signal is equal to 2 symbols, the transmitting apparatus determines that the total time duration is equal to 20 symbols, that is, the number of the first signals M is equal to 10. In some embodiments, the total time duration Tₚᵢₗ may not be an integer multiple of the time duration T. In this case, the time duration of the last of the M first signals is less than T, which may be equal to (M−|M|)T. For example, time duration T of one first signal is equal to 3 symbols, the transmitting apparatus determines that the total time duration is equal to 20 symbols, time duration of the last of 7 first signals is equal to 2 symbols.

In some embodiments, the transmitting apparatus can obtain statistics of the synchronization offset and determine the total time duration based on the obtained statistics. For example, each time a receiving apparatus is woken up, the synchronization offset may be estimated by the transmitting apparatus. In some embodiments, if the receiving apparatus sends the synchronization offset to the transmitting apparatus when it enters into the second state (for example, connected state), the transmitting apparatus may collect these synchronization offsets and extract the statistics that may be used to determine the total time duration of the first signals for this receiving apparatus in the following communication. In these embodiments, the random property of the synchronization offset is considered, appropriate total duration time of the M first signals is determined, and performance of the synchronization is improved.

The transmitting apparatus may design the M first signals for one or more apparatus (e.g., terminals and/or nodes). In some embodiments, configurations of the M first signals are shared among multiple apparatus, that is, multiple apparatus use the same first signals for time synchronization. In these embodiments of the application, the transmitting apparatus may share the same configurations of the M first signals with other apparatus, large transmit power budget could be assigned to the M first signals because multiple apparatus may share the M first signals for time synchronization. The quality of time synchronization could be improved. Moreover, the transmitting apparatus transmits the same M first signals to multiple apparatus, the interference in signals processing could be reduced.

In some embodiments, multiple apparatus are divided into g groups, and each group shares the same configuration of the M first signals, and g is an integer and g is greater than or equal to 2. That is, apparatus that belong to one group use the same LFM rates, starting frequencies and time durations of the M first signals. Apparatus that belong to different groups differ in at least one of a LFM rate, a starting frequency, and a time duration. These embodiments provide more flexibility and more degrees of freedom.

For example, FIG. 11 illustrates an example of two groups of first signals. As shown in FIG. 11, multiple apparatus are divided into two groups, which are named as a first group and a second group. The first signals (pilots) of the first group are characterized by α₁, T₁, f₁ and M₁, the first signals of the second group are characterized by α₂, T₂, f₂ and M₂.

In some embodiments, a frequency interval of two different groups is greater than or equal to a third threshold. The frequency interval of two different groups may be equal to the difference between the minimum value of frequency of one group and the maximum value of frequency of another group, where the frequency of one group is greater than the frequency of the other group, for example, the frequency interval is equal to (f₂+α₂ T₂)−f₁, where α₂ is negative. The third threshold is not limited in this application, for example, the third threshold may be configured by a network, or the third threshold may be predefined (for example, predefined in a standard). In these embodiments of this application, the inter-group interference in signal processing could be reduced.

In some embodiments, the receiving apparatus receives the M first signals using frequency filtering, where the frequency filtering is used to remove or reduce the frequency interference. For example, the frequency filtering may be used to remove or reduce the inter-group interference in signal processing. In these embodiments of this application, the transmitting resource overhead could be reduced.

In some embodiments, the configurations of the multiple first signals have an association relationship with one or more of the following: cell identifier and group identifier. For example, the configurations have an association with the cell identifier, and apparatus associated with the cell identifier can share the same configurations. For another example, the configurations have an association relationship with the group identifier, and apparatus belong to the group share the same configurations. This is not limited in this application.

The N second signals are LFM signals, the design of the N second signals is similar to the design of the M first signals, the description can refer to the above description of the first signals, and this is not repeated here. For example, the time durations of the N second signals may be represented by a time duration sequence [symbol] _{sig} or a time duration parameter T_{sigO}. The LFM rates of the N second signals may be represented by an LFM rate sequence [symbol] _{sig} or an LFM rate parameter α_{sig}. The starting frequencies of N second signals may be represented by a starting frequency sequence [symbol] _{sjg} or a starting frequency parameter f_{sig}.

In some embodiments, the time durations of the M first signals and the time durations of the N second signals are the same. For example, each first signal occupies a symbol and each second signal occupies a symbol. Thus, the complexity of processing the M first signals may be reduced. In some embodiments, the LFM rates of the M first signals and the LFM rates of the second signals could be the same. Thus, the complexity of processing the M first signals may be reduced. In some embodiments, the starting frequencies of the M first signals and the starting frequencies of the N second signals are the same. Thus, the complexity of processing the M first signals may be reduced.

In some embodiments, the transmitting apparatus can generate and transmit the wake-up signals if it determines that the receiving apparatus is to be woken up. For example, in a paging procedure, some of data to be sent to the receiving apparatus arrives at the transmitting apparatus, where the receiving apparatus is in the first state (e.g., an inactive state or idle state). The transmitting apparatus transmits the M first signals so that the receiving apparatus may receive subsequent N second signals based on the M first signals. The M first signals are used for synchronization, and the N second signals are used to transform the receiving apparatus into a second state (e.g., connected state) to receive the data.

In some embodiments, the configurations of the multiple second signals have an association relationship with identity information of the receiving apparatus. For example, the configurations have an association with an identifier of the receiving apparatus. Thus, the transmitting apparatus could determine the identifier of the receiving apparatus to be woken up and generate the multiple second signals based on the identifier and the association relationship.

At S620, the receiving apparatus obtains signatures associated with the multiple second signals based on a timing information, and the timing information obtained from at least part of the multiple first signals.

In some embodiments, the timing information indicates positions of the multiple second signals in a time domain. For example, the total time duration of the M first signals Tₚᵢₗ and the starting time of the M first signals tₒ are known to the receiving apparatus. The receiving apparatus may determine the starting time of the N second signals based on the Tₚᵢₗ and tₒ. For example, the starting time of the N second signals t₁=tₒ+Tₚᵢₗ. Thus, the receiving apparatus may know which parts of the signals captured in the measurement window are the second signals. If the time duration of one time unit is known to the receiving apparatus, the receiving apparatus also may obtain the boundaries of time units in this progress.

In some embodiments, the timing information indicates a synchronization offset between the receiving apparatus and the transmitting apparatus. The synchronization offset may also be referred to as time offset. For example, the receiving apparatus can obtain the synchronization offset based on configurations of the first signals and the starting time of the first signals on receiving side. The starting time of first signals is configured as to. The starting time of the first signals on receiving side is determined to be tₒ′. The synchronization offset may be “tₒ′−tₒ”.

The receiving apparatus processes the signals received in the measurement window (as shown in FIG. 7). For ease of description, the signals received in the measurement window can be referred to as captured signals in this application. In some embodiments, the captured signals include some or all of the M first signals. The receiving apparatus may process the some or part of the M first signals, to obtain a timing information. The timing information can be used to determine the positions of the N second signals in the time domain and boundaries of time units. The captured signals include the N second signals. The receiving apparatus processes the N second signals based on the boundaries of time units, to obtain signatures associated with the N second signals. The signatures associated with the second signals may include at least one of the following: time duration sequence or time duration parameter of the N second signals, LFM rate sequence or LFM rate parameter of the N second signals and starting frequency sequence or the starting frequency parameter of the N second signals.

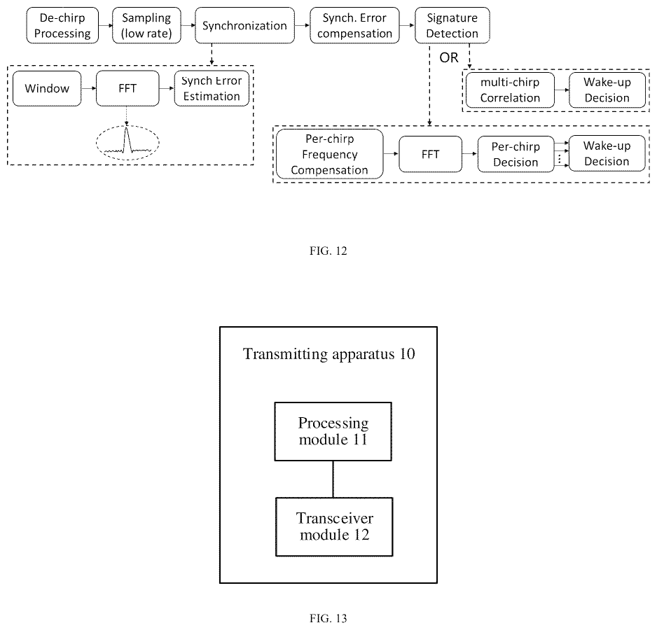

The receiving apparatus may process the captured signals in a variety of ways. For ease of understanding of this application, an example of processing units in the receiving apparatus is given in FIG. 12.

For example, FIG. 12 is a schematic block diagram of an example of a receiving apparatus according to an embodiment of this application. The LFM rates and time durations are fixed over all individual LFM signals belonging to both the M first signals and the N second signals, where a denotes the LFM rate. Considering the same and fixed LFM rates for both the M first signals and the N second signals enables using one de-chirp processing unit which reduces the hardware and operational complexities. Moreover, starting frequencies of all the LFM signals in the M first signals are the same and are denoted by f₀. Also, the starting frequency sequence including the starting frequencies of the individual LFM signals belonging to the N second signals of WUS is [symbol] _{sig}.

For example, the receiving apparatus may apply a de-chirp processing on the captured signals and take samples from the processed signals after de-chirp processing. Next, the receiving apparatus takes a number of initial samples corresponding to the first signals part, which may be referred to as pilot samples. The receiving apparatus may obtain the boundaries of time units based on the pilot samples. For example, the receiving apparatus performs a fast Fourier transformation (FFT) and peak finding on the pilot samples, to obtain the boundaries of time units. In some embodiments, the synchronization offset may also be obtained by the FFT and peak finding operation, where the synchronization offset may be equal to the difference between the starting time of the M first signals and the starting time of the measurement window. The receiving apparatus may obtain the samples corresponding to the second signals part based on the boundaries of the time units and the synchronization offset. That is, the receiving apparatus may separate the samples corresponding to the signature part of the WUS. For ease of description, these samples corresponding to the signature part of the WUS are referred to as samples of the signatures in the following description.

The receiving apparatus may process the samples in a variety of ways. The receiving apparatus may obtain one or more of the following of the N second signals based on the samples of the signatures: time duration sequence or time duration parameter, LFM rate sequence or LFM rate parameter and starting frequency sequence or the starting frequency parameter.

In some embodiments, the receiving apparatus can take the samples of the signatures and obtain the correlation value between the samples of the signatures and the samples of configured signatures, where the configured signatures are the second signals for wake-up that are known to the receiving apparatus before entering a first state. The correlation may indicate the degree of similarity between the samples of the signatures and the sample of the configured signatures, and the greater the correlation value, the higher the degree of similarity between the samples of the signatures and the sample of the configured signatures, and the larger the probability of that the N second signals associated with the receiving apparatus are present in the captured signals. For example, the receiving apparatus determines to wake up when the correlation value is greater than or equal to a second threshold and determines not to wake up when the correlation value is less than the second threshold. The second threshold is not limited in this application, for example, the second threshold may be configured by a network, or the second threshold may be predefined (for example, predefined in a standard).

In some embodiments, the receiving apparatus can perform a compensation operation and an FFT operation on the samples of the signatures. For example, the configured signatures are represented by a time duration parameter T_{sigO}, an LFM rate parameter α_{sig} and starting frequency sequence [symbol] _{sig}. That is, the time durations and the LFM rates of the configured N second signals are the same, and the starting frequencies of at least two configured second signals are different. The receiving apparatus may perform per-LFM frequency compensation on the samples of the signatures using the starting frequency sequence [symbol] _{sig}. The receiving apparatus may perform FFT operation on each single second signal after frequency compensation. Then the receiving apparatus may determine whether each second signal is present in the captured signals or not. The receiving apparatus determines to wake up when each second signal is present in the captured signals and determines not to wake up when not each second signal is present in the captured signals.

At S630, a receiving apparatus transitions from the first state to the second state based on the signatures associated with the multiple second signals.

The receiving apparatus may determine whether the captured signals include its corresponding second signals or not based on the signatures associated with the multiple second signals (e.g., the above sequences or parameters). For example, the LFM rate sequence, [symbol] _{sig} of the N second signals is {0.25, 0.5, 0.25, 0.75}, the starting frequency sequence [symbol] _{sig} of the N second signals is {40, 20, 0, 60} kilo Hertz (kHz), and the time duration T_{sigO} of the N second signals is a single symbol. If the captured signals include the N second signals (four LFM signals) represented by the above sequences and parameter, the receiving apparatus determines to transition from a first state to a second state, that is, the receiving apparatus determines to wake up. If the captured signals do not include the N second signals, the receiving apparatus determines stay in the first state, that is, the receiving apparatus determines not to wake up.

In some embodiments, before at S610, the transmitting apparatus may indicate the receiving apparatus about the configurations of the M first signals before the receiving apparatus enters into the first state. That is, the transmitting apparatus and the receiving apparatus may perform the following at S640.

Optionally, at S640, the transmitting apparatus transmits first configuration information to the receiving apparatus. Correspondingly, the receiving apparatus receives the first configuration information from the transmitting apparatus.

The first configuration information indicates configurations of the M first signals.

In some embodiments, the transmitting apparatus can transmit the first configuration information before the receiving apparatus enters into a first state (a low power consumption state).

The first configuration information may indicate one or more of the following of the M first signals: starting time tₒ, a time duration sequence [symbol] ₚᵢₗ or a time duration parameter Tₚᵢₗₒ, total time duration Tₚᵢₗ, the number of the first signals M, a starting frequency sequence [symbol] ₚᵢₗ or a starting frequency parameter fₚᵢₗ, and a LFM rate sequence [symbol] ₚᵢₗ or a LFM rate parameter αₚᵢₗ. For a more detailed description of these sequences and parameters, please refer to the description above.

For any of the above indicated sequences or parameters, the first configuration information may include the sequences or the parameters, or the first configuration information may include the indexes of the sequences or the parameters, or the first configuration information may include other sequences or parameters where these other sequences or parameters may be used to determine these indicated sequences or parameters. In a first example, the first configuration information includes the starting time to, the time duration parameter Tₚᵢₗₒ, the starting frequency parameter fₚᵢₗ, and the LFM rate parameter αₚᵢₗ. In a second example, the first configuration information includes total time duration Tₚᵢₗ, the number of the first signals M, the starting time tₒ, the starting frequency parameter fₚᵢₗ, and the LFM rate parameter αₚᵢₗ. In a third example, the first configuration information includes the starting time tₒ, the time duration parameter Tₚᵢₗₒ, starting frequency sequence [symbol] ₚᵢₗ and the LFM rate parameter αₚᵢₗ. Thus, the receiving apparatus may determine the starting time of the second signals based on the above parameters and sequences. This is not limited in this application.

Time duration of each first signal may be an integer multiple of the time unit, for example, the time duration of each first signal may be an integer multiple of a single OFDM symbol. The first configuration information may indicate the number of time units of each first signal or the total M first signals. For example, time durations of the M first signals are the same, which is equal to T=Q×T_{sym}, where T_{sym} is the OFDM symbol time duration and Q is a positive integer. The first configuration information may indicate the value of M and Q, and the receiving apparatus may obtain the total time duration of the M fist signals using Tₚᵢₗ=MQT_{sym}.

In some embodiments, the first configuration information can be carried in RRC or MAC-CE. For example, the transmitting apparatus may transmit the first information using RRC or MAC-CE signaling procedures.

In some embodiments, the first configuration information may be transmitted to one or more apparatus (nodes). That is, the configuration of the M first signals may be shared by a group of apparatus (nodes), the M first signals may be referred to as group-based pilot. Alternatively, the configuration of the M first signals may be apparatus (node) specific.

In some embodiments, before S610, the transmitting apparatus may indicate the receiving apparatus about the configuration of the N second signals before the receiving apparatus enters into the first state. That is, the transmitting apparatus and the receiving apparatus may perform the following at S650.

Optionally, at S650, the transmitting apparatus transmits second configuration information, to the receiving apparatus. Correspondingly, the receiving apparatus receives the second configuration information from the transmitting apparatus.

The second configuration information indicates configurations of the N second signals.

In some embodiments, the transmitting apparatus can transmit the second configuration information before the receiving apparatus entering into a first state (a low power consumption state).

The second configuration information may indicate one or more of the following of the N second signals: a time duration sequence [symbol] _{sig} or a time duration parameter T_{sigO}, total time duration T_{sig}, the number of the second signals N, a starting frequency sequence [symbol] _{sig} or a starting frequency parameter f_{sig}, and a LFM rate sequence [symbol] _{sig} or a LFM rate parameter α_{sig}. For a more detailed description of these sequences and parameters, please refer to the description above. The design of the second configuration information is similar to the design of the first configuration information, the description can refer to the above description of the first configuration information, and this is not repeated here.

In some embodiments, the first configuration information and the second configuration information can be carried in one message. For example, the transmitting apparatus may transmit the first configuration information and the second configuration information using a node-specific signaling, where the node-specific signaling is a certain signaling between the certain transmitting apparatus and the certain receiving apparatus. That is, the entire WUS specifications (including the first configuration information and the second configuration information) may be node-specific and the transmitting apparatus may use node-specific signaling to inform each receiving apparatus about the WUS configuration.

In some embodiments, the first configuration information and the second configuration information may be carried in different messages. For example, multiple apparatuses (nodes) share a same configuration of the first signals, the transmitting apparatus may transmit the first configuration information using a node-specific signaling and transmit the second configuration information using a broadcast signaling. That is, the group-based pilot (first signals) is used, the WUS configuration signaling may be divided into two parts: one signaling for the specifications of the shared pilot part and one signaling for the specifications of the node-specific signature part (second signals). Since the signaling of the pilot specification is shared for a group of apparatus (nodes), it can be done through broadcast signaling. Node-specific signaling can also be used for sharing the specifications of the signature part with the apparatus (nodes). This is not limited in this application.

In some embodiments, after S630, if the receiving apparatus determines to wake up, the receiving apparatus may transmit feedback information. That is, the transmitting apparatus and the receiving apparatus may perform the following at S660.

Optionally, at S660, the receiving apparatus transmits feedback information to the transmitting apparatus. Correspondingly, the transmitting apparatus receives the feedback information from the receiving apparatus.

The feedback information may indicate that the receiving apparatus transitions into a second state. For example, the receiving apparatus determines to wake up in the S630, and transmits the feedback information to the transmitting apparatus after transitioning from the first state to the second state (e.g. exiting a low power state and entering a connected state).

In some embodiments, the feedback information indicates the synchronization offset. The receiving apparatus may feedback the synchronization offset determined based on the first signals to the transmitting apparatus. Thus, the transmitting apparatus may adjust the M first signals based on the synchronization offset of feedback. For example, the transmitting apparatus may collect the instances of the estimated synchronization offset and use the statistics of them in order to optimize the total time duration of the M first signals. This is not limited in this application.

In this application, the wake-up signals include M first signals, which can be used for time synchronization. The subsequent N second signals, which can be used to determine whether to wake up, may be processed based on the M first signals. The reliability of the WU procedure could be improved.

The communication method according to the embodiments of this application is described in detail above with reference to FIGS. 6-12, and the transmitting apparatus and the receiving apparatus according to the embodiments of this application will be described in detail below with reference to FIGS. 13-17.

FIG. 13 is a schematic block diagram of a transmitting apparatus 13 according to an embodiment of this application. As shown in FIG. 13, the transmitting apparatus 13 includes:
a processing module 11, configured to generate wake-up signals; and
a transceiver module 12, configured to transmit wake-up signals comprising multiple first signals and multiple second signals, where the multiple first signals and the multiple second signals are linear frequency modulated (LFM) signals, signatures associated with the multiple second signals are obtained based on a timing information, the timing information is obtained from at least part of the multiple first signals, and the signatures associated with the multiple second signals are used for a receiving apparatus to transition from a first state to a second state.

Therefore, signatures associated with the multiple second signals are based on a timing information obtained from at least part of the multiple first signals. That is, the receiving apparatus can process the multiple first signals for a purpose of obtaining timing information of the multiple second signals. The timing information allows the receiving apparatus to reliably obtain the signatures associated with the multiple second signatures. Thus, the reliability of the WU procedure can be improved.

The transmitting apparatus 13 in this embodiment of this application may correspond to the transmitting apparatus in the communication method in the embodiments of this application described above, and the foregoing management operations and/or functions and other management operations and/or functions of modules of the transmitting apparatus 13 are intended to implement corresponding steps of the foregoing methods. For brevity, details are not described herein again.

The transceiver module 12 in this embodiment of this application may be implemented by a transceiver, and the processing module 11 may be implemented by a processor.

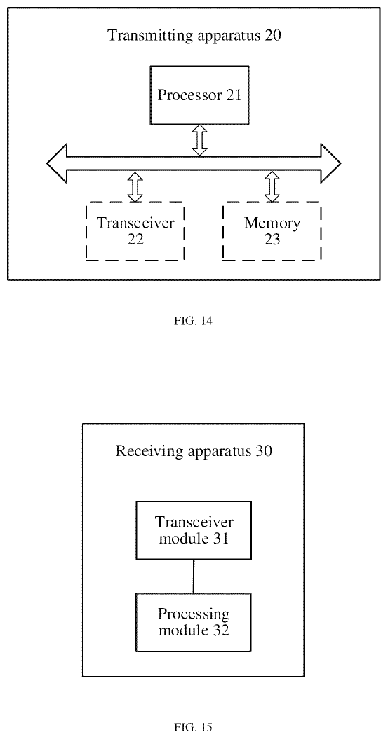

As shown in FIG. 14, a transmitting apparatus 20 may include a transceiver 21. Optionally, the transmitting apparatus 20 may further include a processor 22 and/or a memory 23. The memory 23 may be configured to store indication information, or may be configured to store code, instructions, and the like that is to be executed by the processor 22.

FIG. 15 is a schematic block diagram of a receiving apparatus 30 according to an embodiment of this application. As shown in FIG. 15, the receiving apparatus 30 includes:

a transceiver module 31, configured to receive, in a first state, wake-up signals comprising multiple first signals and multiple second signals, where the multiple first signals and the multiple second signals are linear frequency modulated (LFM) signals;

a processing module 32, configured to obtain signatures with the multiple second signals based on a timing information of the multiple second signals, and the timing information obtained from at least part of the multiple first signals; and transitioning from the first state to a second state based on the signatures associated with the multiple second signals.

The receiving apparatus 30 in this embodiment of this application may correspond to the receiving apparatus in the communication method in the embodiments of this application described above, and the management operations and/or functions and other management operations and/or functions of modules of the receiving apparatus 30 are intended to implement corresponding steps of the foregoing methods. For brevity, details are not described herein again.

The transceiver module 31 in this embodiment of this application may be implemented by a transceiver, and the processing module 32 may be implemented by a processor.

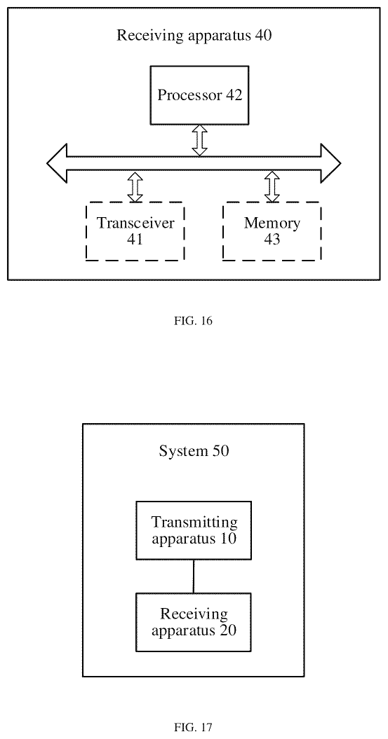

As shown in FIG. 16, a receiving apparatus 40 may include a transceiver 41. Optionally, the receiving apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processing module 21 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or a transistor logic device, or a discrete hardware component. All methods, steps, and logical block diagrams disclosed in these embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

The memory 23 or the memory 43 in the embodiments of the present invention may be a volatile memory or a non-volatile memory or may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM) and may be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

An embodiment of this application further provides a system. As shown in FIG. 17, a system 50 includes:

the transmitting apparatus 10 according to the embodiments of this application and the receiving apparatus 20 according to the embodiments of this application.

An embodiment of this application further provides a computer storage medium, and the computer storage medium may store a program instruction for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division, and other methods of division may be used in an actual embodiment. For example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit or may be distributed among a plurality of network units. Some or all of the units may be selected based on actual requirements to achieve the objectives of the embodiments.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method comprising:
receiving, in a first state, wake-up signals comprising multiple first signals and multiple second signals, wherein the multiple first signals and the multiple second signals are linear frequency modulated (LFM) signals;
obtaining signatures associated with the multiple second signals based on timing information of the multiple second signals, the timing information being obtained from at least part of the multiple first signals; and
transitioning from the first state to a second state based on the signatures associated with the multiple second signals.

2. The method of claim 1, wherein a total time duration of the multiple first signals is greater than or equal to a first threshold.

3. The method of claim 1, wherein a total time duration of the multiple first signals is determined at least based on first information, and the first information indicates a communication environment of a receiving apparatus.

4. The method of claim 1, wherein the timing information indicates positions of the multiple second signals in the time domain.

5. The method of claim 1, wherein the timing information indicates a synchronization offset between a receiving apparatus and a transmitting apparatus, and the synchronization offset is obtained from at least part of the multiple first signals.

6. A method comprising:
transmitting wake-up signals comprising multiple first signals and multiple second signals, wherein the multiple first signals and the multiple second signals are linear frequency modulated (LFM) signals, signatures associated with the multiple second signals are obtained based on timing information, the timing information is obtained from at least part of the multiple first signals, and the signatures associated with the multiple second signals are used for a receiving apparatus to transition from a first state to a second state.

7. The method of claim 6, wherein a total time duration of the multiple first signals is greater than or equal to a first threshold.

8. The method of claim 6, wherein a total time duration of the multiple first signals is determined at least based on first information, and the first information indicates a communication environment of the receiving apparatus.

9. The method of claim 6, wherein the timing information indicates positions of the multiple second signals in the time domain.

10. The method of claim 6, wherein the timing information indicates a synchronization offset between the receiving apparatus and a transmitting apparatus, and the synchronization offset is obtained from at least part of the multiple first signals.

11. An apparatus comprising:
at least one processor; and
a memory coupled to the at least one processor, the memory storing instructions that, when executed by the at least one processor, cause the apparatus to:
receive, in a first state, wake-up signals comprising multiple first signals and multiple second signals, wherein the multiple first signals and the multiple second signals are linear frequency modulated (LFM) signals;
obtain signatures associated with the multiple second signals based on timing information of the multiple second signals, the timing information being obtained from at least part of the multiple first signals; and
transition from the first state to a second state based on the signatures associated with the multiple second signals.

12. The apparatus of claim 11, wherein a total time duration of the multiple first signals is greater than or equal to a first threshold.

13. The apparatus of claim 11, wherein a total time duration of the multiple first signals is determined at least based on first information, and the first information indicates a communication environment of the apparatus.

14. The apparatus of claim 11, wherein the timing information indicates positions of the multiple second signals in the time domain.

15. The apparatus of claim 11, wherein the timing information indicates a synchronization offset between the apparatus and a transmitting apparatus, and the synchronization offset is obtained from at least part of the multiple first signals.

16. An apparatus comprising:
at least one processor; and
a memory coupled to the at least one processor, the memory storing instructions that, when executed by the at least one processor, cause the apparatus to:
transmit wake-up signals comprising multiple first signals and multiple second signals, wherein the multiple first signals and the multiple second signals are linear frequency modulated (LFM) signals, signatures associated with the multiple second signals are obtained based on timing information, the timing information is obtained from at least part of the multiple first signals, and the signatures associated with the multiple second signals are used for a receiving apparatus to transition from a first state to a second state.

17. The apparatus of claim 16, wherein a total time duration of the multiple first signals is greater than or equal to a first threshold.

18. The apparatus of claim 16, wherein a total time duration of the multiple first signals is determined at least based on first information, and the first information indicates a communication environment of the receiving apparatus.

19. The apparatus of claim 16, wherein the timing information indicates positions of the multiple second signals in the time domain.

20. The apparatus of claim 16, wherein the timing information indicates a synchronization offset between the receiving apparatus and the apparatus, and the synchronization offset is obtained from at least part of the multiple first signals.
